(19) United States
(12) Patent Application Publication
(10) Pub. No.: US 2009/0086353 A1
(43) Pub. Date: Apr. 2, 2009

(54) Bank Structure for a Display Panel and Method of Manufacturing the Same

(75) Inventors: Lun Tsai, Hsinchu (TW); Chi-Sheng Chen, Hsinchu (TW); Po-Hua Lung, Hsinchu (TW); Wen-Bin Wu, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/040,162

(22) Filed: Feb. 29, 2008

(30) Foreign Application Priority Data
Oct. 1, 2007 (TW) 96136762

(51) Int. Cl. G02B 5/20; G02B 5/00; G02B 1/00

(52) U.S. Cl. 359/896; 430/6

(57) ABSTRACT

A bank structure for a display panel is provided. The display panel comprises a substrate, and the bank structure is formed on the surface of the substrate. The bank structure comprises a periphery and a partition, wherein the periphery forms a receiving space with the substrate and the partition is disposed in the receiving space for separating the receiving space into two sub-spaces with fluid-communication. Therefore, the ink can be injected and uniformly distributed in the sub-spaces to overcome the disadvantages of poor injection precision and increasing the spray control of the ink.

This application claims the benefit from the priority of Taiwan Patent Application No. 096136762, filed on Oct. 1, 2007, the contents of which are herein incorporated by reference in their entirety.

### CROSS-REFERENCES TO RELATED APPLICATIONS

Not applicable.

### BACKGROUND OF THE INVENTION

1. Field of the Invention

The present invention relates to a bank structure for a display panel. More particularly, the present invention relates to a bank structure capable of improving ink distribution for a display panel.

2. Descriptions of the Related Art

Conventionally, a widely adopted method for manufacturing a large color filter is the pigment dispersed method. According to this method, a black photo-resist containing carbon is applied onto a glass substrate using a photo process, and then subjected to a series of processes such as soft baking, exposure, development and hard baking, thereby, forming a black matrix on the substrate as a bank structure to shield light. When used in a color filter, the bank structure functions to shield light leaked due to the disorderly arrangement of the liquid crystal molecules in inactive regions. Generally, the regions that are shielded by the bank structure comprise lines, transistors and common electrodes on the substrate, among which the main light leakage occurs at the edge of the transistor lines. Therefore, the bank structure at such locations must have a larger width than the transistor lines. Because the bank structure helps to enhance the contrast of the liquid crystal display (LCD), it has been widely applied in current LCD products.

Subsequent to the formation of the black matrix, the ink containing a pigment is applied using a similar photo process to yield the color filters of various colors. However, as the substrates become increasingly larger in size, the technologies of producing color filters by ink injection have also been developed. The ink injecting method is characterized by a large spray-coating area, a simple manufacturing process and a reduced material cost. In addition to being used for producing red, green and blue (R, G, and B) color filters, the method may also be used to form spacer balls and polyimide (PI).

In producing a color filter by ink injection, a bank is first formed on the surface of a glass substrate, and then ink is injected by a precision ink injection apparatus into the receiving space formed by the bank. Unfortunately, when the ink is dropped into the receiving space formed by the bank, a small volume of the receiving space or discontinuous and asymmetric areas of the receiving space that are divided by common electrodes or other electrodes often lead to poor injection precision and poor injection dose accuracy. This tends to cause underfilling or an ink drop to protrude in the center portion thereof, thereby making the edges or corners of the receiving space devoid of ink. Also possibly, the incorrect injecting locations or ununiform injection dose may even cause ink to overflow and mix with the ink of other colors in the adjacent pixels, thus resulting in a decreased yield.

It follows from the above description that because of the poor ink injection precision and poor injection dose accuracy in producing color filters by ink injection, there is still no bank structure that can prevent these problems. Accordingly, it is still highly desirable in the art to provide a bank structure complying with both the requirements described above.

### SUMMARY OF THE INVENTION

One objective of this invention is to provide a bank structure for a display panel, wherein the display panel comprises a substrate. The bank structure is formed on the surface of the substrate. The bank structure comprises a periphery and a partition. The periphery and the substrate both form a receiving space, into which the partition divides the receiving space into a first sub-space and a second sub-space in fluid communication with each other. When dropped into the receiving space, ink will fill into the first sub-space and the second sub-space. In this way, ink will be distributed uniformly in the receiving space, thus improving the ink injection precision and injection dose accuracy and prevent ink overflow and consequent color mixtures with the adjacent pixels. Furthermore, the extension of the receiving space may also mitigate the central protrusion of an ink drop in a limited space due to the surface tension and cohesion.

To this end, the periphery has a first vertical dimension, and the partition has a second vertical dimension smaller than the first vertical dimension. As a result, a fluid communication is established between the first sub-space and the second sub-space, so that when the ink is dropped therein, the ink will be allowed to flow between the two sub-spaces over the partition.

Another objective of this invention is to provide a method of manufacturing a bank structure for a display panel, in which a bank is formed with different vertical dimensions by a patterning process to obtain the aforesaid bank structure.

Yet a further objective of this invention is to provide a method of manufacturing a bank structure for a display panel, in which the smaller vertical dimension is formed at the borders where the peripheries of the adjacent receiving spaces of the same color adjoin with each other, to establish a fluid communication between the different receiving spaces of the same color.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1a illustrates a bank structure of this invention;

FIG. 1b is a cross-sectional view taken along line A-A′ in FIG. 1a;

FIG. 1c is a cross-sectional view taken along line B-B′ in FIG. 1a;

FIGS. 2a to 2c are schematic views of a manufacturing method of this invention;

FIG. 3a illustrates another embodiment of this invention;

FIG. 3b is a schematic cross-sectional view taken along line C-C′ in FIG. 3a;

FIG. 4a is a schematic view of yet a further embodiment of this embodiment; and

FIG. 4b is a schematic cross-sectional view taken along line D-D′ in FIG. 4a.

### DESCRIPTION OF THE PREFERRED EMBODIMENT

The following embodiments and attached drawings are intended to illustrate rather than to limit this invention. It should be noted that the elements unrelated to this invention have been omitted from depiction in the following embodiments and attached drawings.

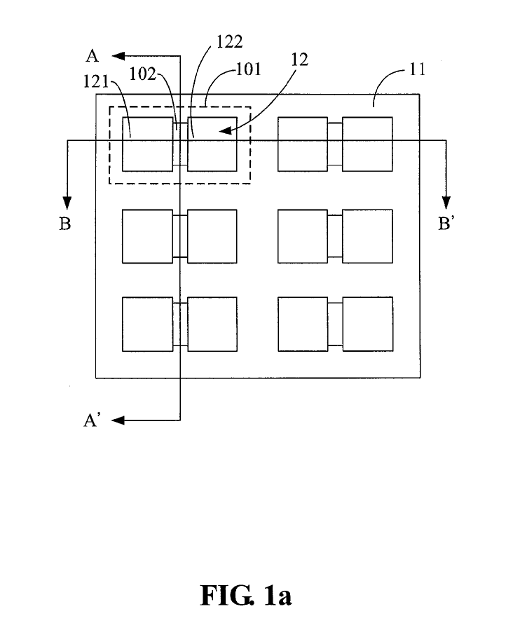

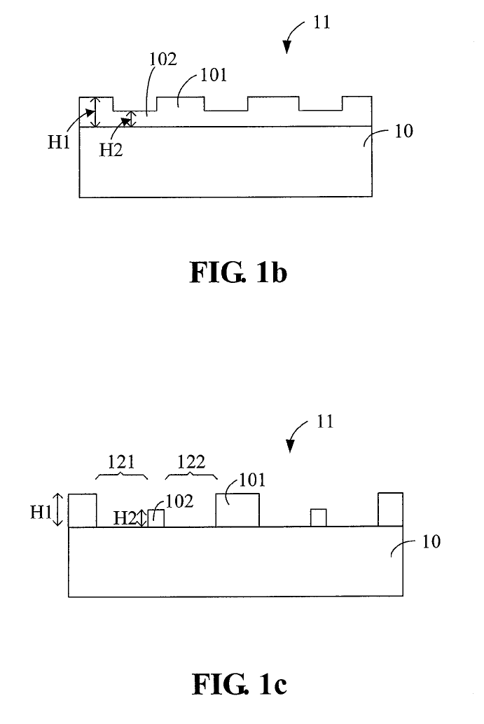

FIG. 1a illustrates a bank structure 11 of this invention when applied in a display panel, while FIG. 1b and FIG. 1c illustrate a cross-sectional view of a portion of the bank structure 11 respectively. More specifically, FIG. 1b is a cross-sectional view taken along line A-A′ in FIG. 1a, while FIG. 1b is a cross-sectional view taken along line B-B′ in FIG. 1a.

The bank structure 11 depicted in FIG. 1a is formed on a substrate 10, and comprises a periphery 101 and a partition 102. The periphery 101 forms a receiving space 12, into which the partition 102 is disposed. In FIG. 1a, identical depictions represent identical structures. In other words, FIG. 1a depicts a plurality of receiving spaces, each of which has a similar structure to that of the receiving space 12.

In reference to both FIGS. 1b and 1c, the periphery 101 has a first vertical dimension H1, and the partition 102 has a second vertical dimension H2 smaller than the first vertical dimension H1. Consequently, the periphery 101 can define a receiving space 12 for receiving ink. The receiving space 12 uses the periphery 101 as a peripheral wall thereof and has a first vertical dimension H1. The partition 102 is disposed in the receiving space 12 and is connected integrally with the periphery 101 to divide the receiving space 12 into a first sub-space 121 and a second sub-space 122. Because the partition 102 has a vertical dimension H2 smaller than H1, a fluid communication crossing over the partition 102 is established between the first sub-space 121 and the second sub-space 122. That is, when dropped into the receiving space 12, ink may fill into both the first sub-space 121 and the second sub-space 12. As a result, the ink will be distributed uniformly in the receiving space 12 to result in a better ink injection precision and injection dose accuracy. The receiving space 12 corresponds to one of the pixel structures in the display panel, while the partition 102 corresponds to one of the common electrodes (not shown) of this pixel structure to shield the common electrode from leaking light.

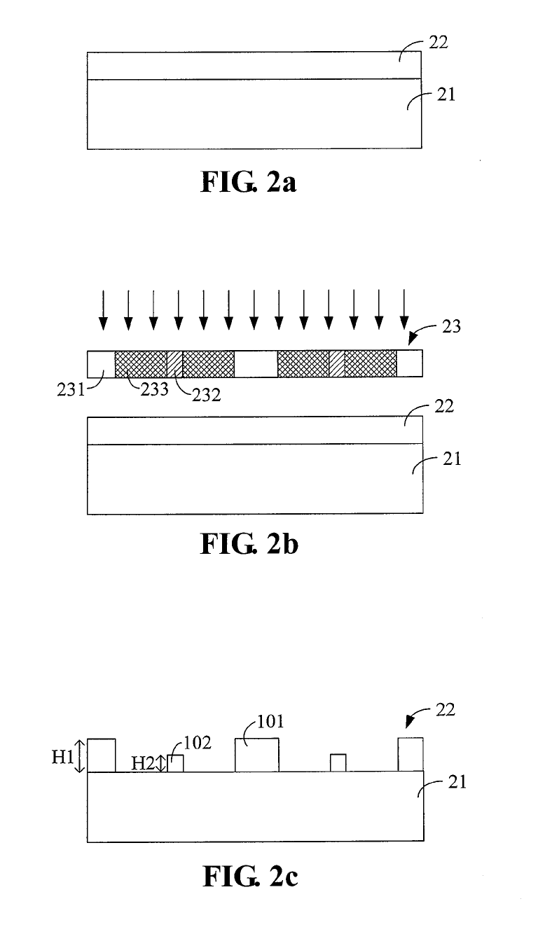

FIGS. 2a to 2c depict a flow diagram of the process for manufacturing the bank structure 11 in FIG. 1a, in which a halftone mask process is used as an example. Initially, as shown in FIG. 2a, a material layer 22 is formed across the substrate 21 of a display panel. The material layer 22 may be formed from an opaque and photosensitive organic material, for example, a deep colored photosensitive resin to adapt to a subsequent halftone mask process. FIG. 2b depicts an exposure process used on the material 22 through a halftone mask 23. In this embodiment, the material layer 22 is formed from deep colored photosensitive resin of negative photo-resistive nature. The halftone mask 23 may include full-exposure areas 231, half-exposure areas 232 and non-exposure areas 233. Portions of the material layer 22 corresponding to the full-exposure areas 231 are cured subsequently to an exposure process; portions of the material layer 22 corresponding to the half-exposure areas 232 are half cured subsequently to the exposure process and are partially removed in a subsequent development process; and portions of the material layer 22 corresponding to the non-exposure areas 233 remain unchanged without subsequent curing and are removed completely in the subsequent development process. The patterned material layer 22 resulted from the exposure process is illustrated in FIG. 2c. At this point, the patterned material layer 22 forms the bank structure 11 comprising a periphery 101 and a partition 102 as depicted in FIG. 1C. In the invention, the material layer 22 could also be formed from deep colored photosensitive resin of positive photo-resist which takes a mask with reversed full-exposure and non-exposure area.

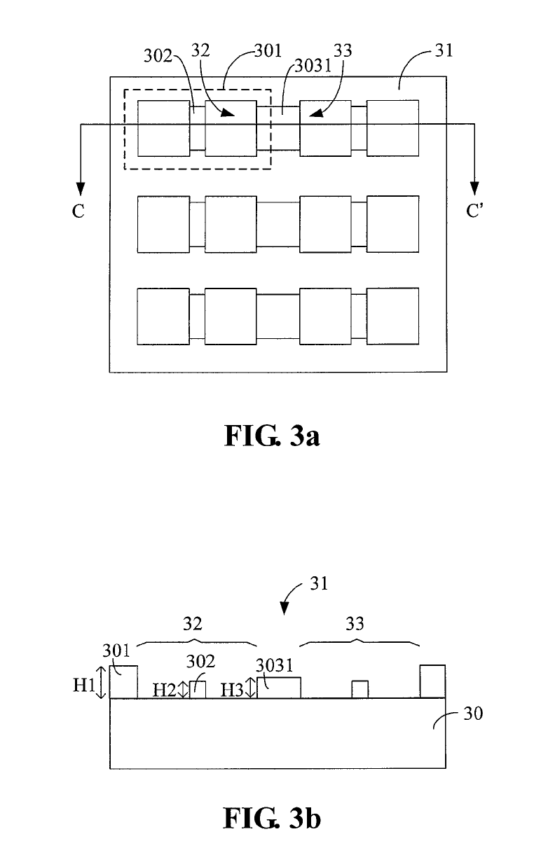

FIG. 3a illustrates a schematic view of another bank structure 31 of this invention, and FIG. 3b is a cross-sectional view of a portion of the bank structure 31 taken along line C-C′ in FIG. 3a. The bank structure 31 is formed on a substrate 30, and comprises a periphery 301 and a partition 302. Unlike the bank structure shown in FIG. 1a, the periphery 301 has a portion 3031 formed with a third vertical dimension H3 smaller than the first vertical dimension H1, as shown in FIG. 3b. Consequently, a fluid communication may be established between the receiving space 32 and another receiving space 33. That is, ink dropped into the receiving space 32 will also fill in the receiving space 33. Conceivably, in this embodiment, the fluid communication design will only apply to the receiving spaces that will be filled with ink of the same color.

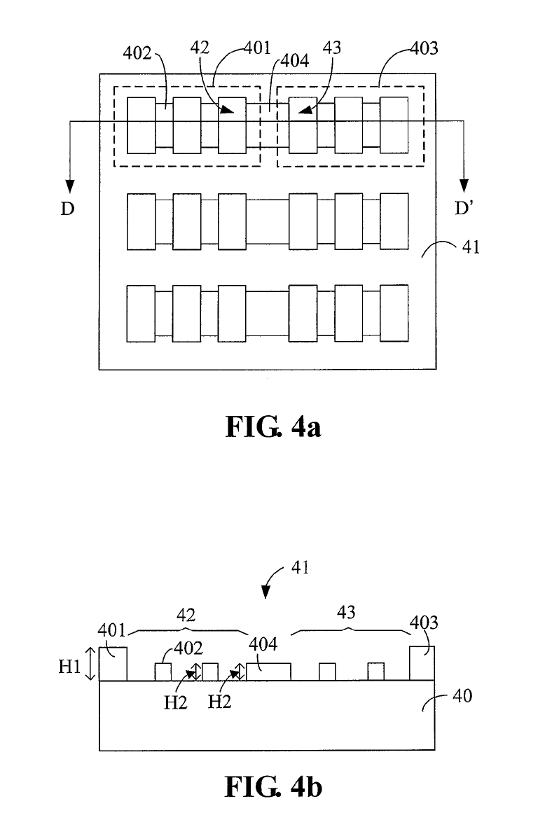

FIG. 4a illustrates a bank structure 41 in accordance with another embodiment of this invention, while FIG. 4b is a cross-sectional view of a portion of the bank structure 41 taken along line D-D′ in FIG. 4a. The bank structure 41 is formed on a substrate 40, and comprises a first periphery 401, a plurality of partitions 402 and a second periphery 403. The first periphery 401 has a first vertical dimension H1 and defines a first receiving space 42. The second periphery 403, which also has the first vertical dimension H1, adjoins the first periphery 401 and defines a second receiving space 43. On the other hand, the partition 402 has a second vertical dimension H2 smaller than the first vertical dimension H1. Unlike what is shown in FIG. 1a and FIG. 3a, a portion of the bank structure 404 where the periphery 401 of the first receiving space 42 adjoins the periphery 403 of the second receiving space 43 is formed with the second vertical dimension H2, so that the ink dropped into these receiving spaces will flow over the partitions 42. Similarly, the first receiving space 42 and the second receiving space 43 shall be filled with ink of the same color.

It should be noted that the bank structures shown in FIG. 3a and FIG. 4a can both be formed by the manufacturing process illustrated in FIG. 2a to FIG. 2C. Furthermore, all the above bank structures may also be formed by other appropriate mask processes, for example, a gray-scale mask process, a spacer mask process, or a dual-mask process with different exposing energy. These mask processes are characterized in that subsequent to the development process, a bank with different vertical dimensions will be formed, thus obtaining a bank structure of this invention. Such a process may be readily substituted by those of ordinary skill in the art, and is not just limited thereto.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A bank structure for a display panel, the display panel comprising a substrate which has a surface, the bank structure being formed on the surface of the substrate, the bank structure comprising:
a periphery having a first vertical dimension, in which the periphery and the substrate are formed with a receiving space; and
a partition having a second vertical dimension, in which the partition is disposed in the receiving space and connects with the periphery to divide the receiving space into a first sub-space and a second sub-space;
wherein the first vertical dimension is larger than the second vertical dimension, whereby, a fluid-communication is formed between the first sub-space and the second sub-space.

2. The bank structure as claimed in claim 1, wherein the periphery and the partition are made of opaque organic material.

3. The bank structure as claimed in claim 1, wherein the periphery and the partition are made of photosensitive organic material.

4. The bank structure as claimed in claim 1, wherein the periphery partially has a third vertical dimension smaller than the first vertical dimension, whereby the receiving space is outwardly fluid-communicated.

5. The bank structure as claimed in claim 4, wherein the receiving space is outwardly fluid-communicated with another receiving space.

6. The bank structure as claimed in claim 1, wherein the receiving space is configured to receive ink.

7. The bank structure as claimed in claim 6, wherein the receiving space corresponds to a pixel structure.

8. The bank structure as claimed in claim 7, wherein the partition corresponds to the pixel structure at a common electrode thereof.

9. A method of manufacturing a bank structure for a display panel, comprising steps of:
providing a substrate;
forming a material layer on the substrate; and
forming a periphery with a first vertical dimension and a partition with a second vertical dimension by patterning the material layer, wherein the periphery and the substrate are formed with a receiving space, the partition is formed within the receiving space, and the first vertical dimension is larger than the second vertical dimension.

10. The method as claimed in claim 9, wherein the partition divides the receiving space into a first sub-space and a second sub-space in which a fluid-communication is formed therebetween.

11. The method as claimed in claim 9, further comprising a step of: injecting ink into the receiving space.

12. The manufacturing method as claimed in claim 9, wherein the material layer is made of photosensitive organic material, and the step of forming a periphery and a partition comprising:
performing an exposure process to the material layer with a halftone mask; and
forming the periphery with the first vertical dimension and the partition with the second vertical dimension by performing a development process.

13. The manufacturing method as claimed in claim 9, wherein the step of forming a periphery and a partition is processed by performing a process selected from the group of: a halftone mask process, a gray-level mask process, a spacer mask process, and two-masks process with different exposing energy.

14. The manufacturing method as claimed in claim 9, wherein the step of forming a periphery and a partition further forming the periphery partially with a third vertical dimension which is smaller than the first vertical dimension.

15. A method of manufacturing a bank structure for a display panel, comprising the steps of:
providing a substrate;
forming a material layer on the substrate; and
patterning the material layer to form:
a first periphery, defining a first receiving space;
a second periphery, defining a second receiving space adjacent to the first periphery; and
a plurality of partitions, being located within the first receiving space and the second receiving space;
wherein the first periphery and the second periphery both have a first vertical dimension, the partitions and a adjacent portion located between the first periphery and the second periphery have a second vertical dimension, and the first vertical dimension is larger than the second vertical dimension.

16. The method as claimed in claim 15, wherein a fluid-communication is formed between the first receiving space and the second receiving space.

17. The method as claimed in claim 15, further comprising a step of: injecting ink into the first receiving space and the second receiving space.

18. The method as claimed in claim 17, wherein the step of injecting ink is injecting ink with same color in to the first receiving space and the second receiving space.

19. The method as claimed in claim 15, wherein the material layer is made of photosensitive organic material, and the step of patterning the material layer comprises:
performing an exposure process to the material layer with a halftone mask; and
forming the first periphery, the second periphery, and the partitions by performing a development process.

20. The method as claimed in claim 15, wherein the step of patterning the material layer is processed by performing a process selected from the group of: a halftone mask process, a gray-level mask process, a spacer mask process, and two-masks process with different exposing energy.
